(19) United States
(12) Patent Application Publication
(10) Pub. No.: US 2007/0246999 A1
(43) Pub. Date: Oct. 25, 2007

(54) Compressed air supply device and method for operating a compressed air supply device

(75) Inventor: Eduard Hilberer, Hockenheim (DE)

Correspondence Address: CROWELL & MORING LLP;INTELLECTUAL PROPERTY GROUP, P.O. BOX 14300, WASHINGTON, DC, 20044-4300, US

(73) Assignee: Knorr-Bremse Systeme fuer Nutzfahrzeuge GmbH, Muenchen (DE)

(21) Appl. No.: 11/790,462

(22) Filed: Apr. 25, 2007

Related U.S. Application Data
(63) Continuation of application No. PCT/EP05/11190, filed on Oct. 18, 2005.

(30) Foreign Application Priority Data
Oct. 25, 2004 (DE) 10 2004 051 812.2

(51) Int. Cl. B60T 15/16; G05D 7/00

(52) U.S. Cl. 303/13; 700/282

(57) ABSTRACT

A compressed air supply device includes at least one compressed air inlet and a plurality of compressed air outlets for supplying a plurality of brake circuits of a utility vehicle with treated compressed air. A control unit controls processes relating to the compressed air supply. A valve device that can be controlled by the control unit is used to directly control the filling of bellows of a pneumatic lifting axle device with treated compressed air and the removal of said air from the same.

### CROSS-REFERENCE TO RELATED APPLICATIONS

This application is a continuation of PCT International Application No. PCT/EP2005/011190, filed on Oct. 18, 2005, which claims priority under 35 U.S.C. §119 to German Application No. 10 2004 051 812.2, filed Oct. 25, 2004, the entire disclosures of which are expressly incorporated by reference herein.

### BACKGROUND AND SUMMARY OF THE INVENTION

The invention relates to a compressed air supply device having at least one compressed air inlet and a plurality of compressed air outlets for supplying a plurality of brake circuits of a utility vehicle with treated compressed air, and having a control unit for controlling processes associated with the compressed air supply.

The invention also relates to a method for operating a compressed air supply device having at least one compressed air inlet and a plurality of compressed air outlets for supplying a plurality of brake circuits of a utility vehicle with treated compressed air, and having a control unit for controlling processes associated with the compressed air supply.

Compressed air supply devices or air treatment systems are used in utility (commercial) motor vehicles to supply brake systems with treated, that is to say in particular dried, air. The air which is treated in the air treatment system is extracted from the air treatment system via compressed air outlets and stored in compressed air tanks for further use by the brake circuits.

In addition to the brake system, other consumers are also supplied with compressed air by the generic compressed air supply devices. For example, an outlet is provided on compressed air supply devices, by which outlet the primary compressed air for a lift axle device is provided. The compressed air outlet is separated from the rest of the system by way of an overflow valve with limited return flow. The lift axle device provides the spring bellows, which are assigned to the rear axles, with compressed air by way of a valve device, with the processes being monitored and controlled by an electronic lift axle controller.

The invention is based on the object of providing a compressed air supply device and a method for operating a compressed air supply device, such that the total technical expenditure in the motor vehicle can be reduced.

This, and other, objects are achieved by the present invention, which is based on the generic compressed air supply in that a valve device which can be actuated by the control unit is provided. The valve device directly controls the filling and venting of spring bellows of a pneumatic lift axle device with treated compressed air. The control of the lift axle device is thereby integrated into a compressed air supply device, which is provided both for the supply of the brake system and of the usual auxiliary consumers and for the supply of the lift axle device. In contrast to the prior art, the compressed air supply device does not only serve to primarily provide the compressed air; moreover, the control processes are also carried out directly by the compressed air supply device. The overall system is hereby simplified, since the electronic controller of a conventional air treatment system can jointly take on the tasks of the lift axle controller; the overflow valve conventionally provided for providing the pressure for the lift axle device can thereby be dispensed with.

It is expediently provided that a 3/2 valve and a 2/2 valve, which is connected downstream of the 3/2 valve in the supply flow direction, are provided, with it being possible for the 3/2 valve to be switched between “filling” and “venting” and for the 2/2 valve to be switched between the states “open” and “blocked”. The processes required in terms of the lift axle device can be controlled by means of such a combination of valves.

It can also be provided that a further 2/2 valve is connected downstream of the 3/2 valve in the supply flow direction, which further 2/2 valve can be switched between the states “open” and “blocked”, and that each of the 2/2 valves is provided for filling one spring bellows.

According to one preferred embodiment of the present invention, it is provided that the 2/2 valves can be actuated together. This keeps the technical expenditure with regard to the design of the electronic controller low.

It is, however, also contemplated that the 2/2 valves can be actuated separately. In this way, the spring bellows can be filled and vented individually.

It can be expedient for a throttle to be provided, which throttle permits an overflow of compressed air between spring bellows. This ensures that, with time, an identical pressure level is always generated in the spring bellows.

It is preferable that, for the compressed air supply of the lift axle device, a pneumatic pilot controller is provided. It is hereby possible for low-power solenoid valves to be used, while nevertheless providing high shift forces for switching the valve device.

The invention is particularly advantageously refined in that the compressed air supply device has an air treatment module and a lift axle module, in that the valve device for the supply of the pneumatic lift axle device is arranged in the lift axle module which is connected by a sealing to the compressed air treatment module, and in that pilot-control solenoid valves for the pneumatic pilot control of the valve device are arranged in the air treatment module. If proceeding from a conventional compressed air supply device without the capability of controlling the lift axle device, then this can be functionally identified by the component which is referred to within the context of the present invention as an air treatment module, to which a further module, specifically the lift axle module, is connected. The integration of the two modules to form a compressed air supply device need not be restricted to the common utilization of the electronic controller. Moreover, the pilot-control solenoid valves, which are assigned to the valve device of the lift axle module, are arranged within the air treatment module.

It is expediently provided that a supply line of the service brake circuit and a supply line of the lift axle device branch off from a common supply line. The common supply line proceeds from a non-return valve arranged downstream of the drier cartridge in the supply flow direction. An additional pressure limiter can be provided in the supply line, which branches off to the brake circuits.

The invention is based on the generic method in that a valve device for directly controlling the filling and venting of spring bellows of a pneumatic lift axle device with treated compressed air is actuated by the control unit. In this way, the advantages and special features of the compressed air supply device according to the invention are also implemented within the context of a method. This also applies to the particularly preferred embodiments of the method according to the invention which are specified below.

The inventive method is expediently refined in that a 3/2 valve and a 2/2 valve, which is connected downstream of the 3/2 valve in the supply flow direction, are provided, with the 3/2 valve being switched between “filling” and “venting” and the 2/2 valve being switched between the states “open” and “blocked”.

It can likewise be provided that a further 2/2 valve is connected downstream of the 3/2 valve in the supply flow direction, which further 2/2 valve is switched between the states “open” and “blocked”, and in that each of the 2/2 valves is provided for filling one spring bellows.

It can be expedient that the 2/2 valves are actuated together.

According to another preferred embodiment, it is advantageous that the 2/2 valves are actuated separately.

The method according to the invention is expediently refined in that, for the compressed air supply of the lift axle device, pneumatic pilot control is carried out.

The invention also relates to a utility motor vehicle having a compressed air supply device according to the invention.

The invention is based on the knowledge that, by integrating the air treatment system, the components of the compressed air supply which are connected to the air treatment system, and the lift axle controller, the overall technical expenditure can be reduced. On the one hand, the same electronic controller can be used for all control tasks. On the other hand, it is possible to dispense with components in the compressed air supply device which have conventionally served to ensure the primary compressed air supply of the external lift axle control.

Other objects, advantages and novel features of the present invention will become apparent from the following detailed description of the invention when considered in conjunction with the accompanying drawings.

### BRIEF DESCRIPTION OF THE DRAWINGS

FIG. 1 is a circuit diagram of a preferred embodiment of a compressed air supply according to the invention, and components which are connected thereto; and

FIG. 2 shows a compressed air supply device according to the invention in a partially sectioned illustration.

### DETAILED DESCRIPTION OF THE DRAWINGS

In the following description of the drawings, the same reference symbols are used to denote identical or comparable components.

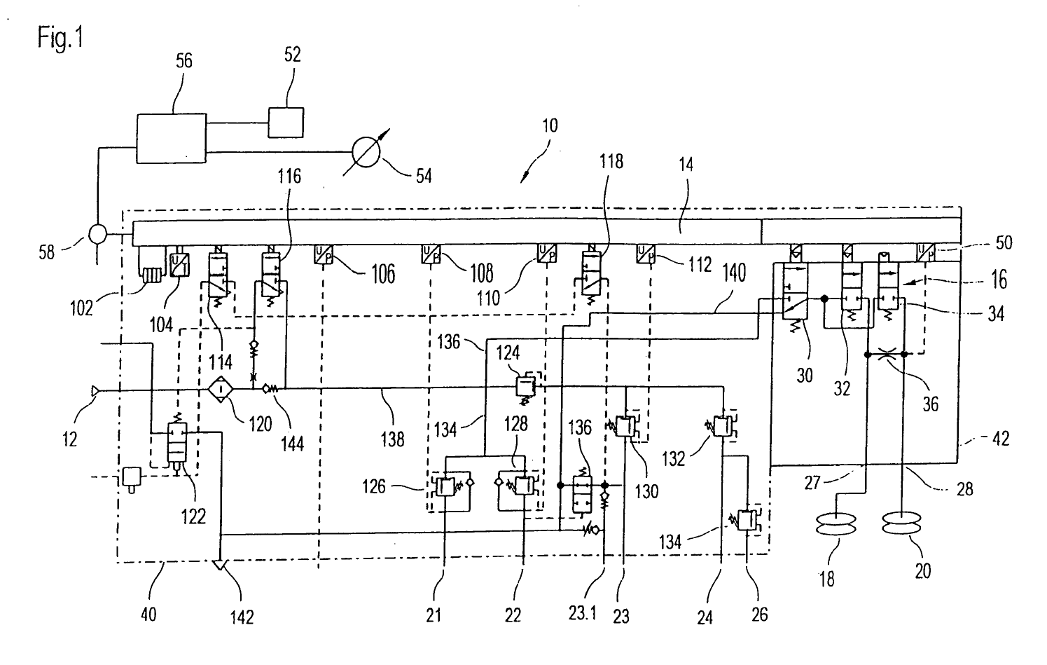

FIG. 1 is a circuit diagram of a preferred embodiment of a compressed air supply according to the invention, and components which are connected thereto.

Those components of the compressed air supply device 10 which are less important for the understanding of the invention are discussed in cursory fashion below. The following components are connected within the compressed air supply device 10 to the electronic controller 14: a heater 102, a temperature sensor 104, a plurality of pressure sensors 106, 108, 110, 112, a solenoid valve for pressure regulator control, a solenoid valve 116 for regeneration control, and a further solenoid valve 118 which is assigned to the parking brake system. Also provided are a drier cartridge 120, a blow-off valve 122, a pressure limiter 124, a plurality of overflow valves 126, 128, 130, 132, which are partially bypassed by non-return valves and throttles, a further 2/2 valve, and a plurality of other non-return valves and throttles.

The compressed air supply device 10 is designed overall so as to include an air treatment module 40 and a lift axle module 42. Compressed air is supplied to the air treatment module 40 via a compressed air inlet 12. The compressed air can, on the one hand, be supplied to the outlets 21, 22, 23.1, 23, 24, 26; on the other hand, the compressed air is supplied to the valve device 16 of the lift axle module 42. The valve device 16 comprises a 3/2 valve 30 and two 2/2 valves 32, 34, which are arranged in parallel downstream of the 3/2 valve. The 3/2 valve and the 2/2 valves are actuated by the electronic controller 14, with pilot solenoid valves being provided for the pneumatic pilot control of the valves. The pressure for the pneumatic actuation of the valves is preferably extracted from the air treatment module 40 at a junction which is arranged upstream of the pressure limiter 124 in the flow direction. The pneumatic spring bellows 18, 20 of the lift axle device are supplied directly by way of the 2/2 valves 32, 34 via the outlets 27, 28. For pressure equalization in the pneumatic spring bellows 18, 20, a throttle 36 is provided, which couples the two pneumatic spring bellows 18, 20. Furthermore, a pressure sensor 50 is provided for determining the pressure in the pneumatic spring bellows 18, 20.

In the illustrated switching state of the valve device 16, the pneumatic spring bellows 18, 20 are decoupled both from the compressed air reservoir and from the vent. If the 2/2 valves 32, 34 are moved into the switching state (not illustrated), then venting of the pneumatic spring bellows 18, 20 can take place in the illustrated switching state of the 3/2 valve 30. If the 2/2 valves are left in the switching state (not illustrated) and the switching state of the 3/2 valve 30 is changed, so that the latter assumes the switching state (not illustrated), the pneumatic spring bellows 18, 20 are filled.

The supply line 134 of the service brake circuit and the supply line 136 of the lift axle device branch off from a common supply line 138. The common supply line 138 proceeds from a non-return valve 144, which is arranged downstream of the drier cartridge 120, in the supply flow direction. An additional pressure limiter (not illustrated) can be provided in the supply line, which branches off to the brake circuits. A venting line 140 of the lift axle device opens out into a vent 142, which is common to the air treatment module 40 and the lift axle module 42. On account of the common filling and venting of the air treatment module and lift axle module, an additional backup for the supply of the lift axle module 42 is not necessary.

The described control processes of the lift axle device are carried out, in particular, as a function of the operation of external components. For example, a remote control 52 and a travel sensor 54 are provided, which are connected by way of a vehicle controller 56 to the central plug 58 of the compressed air supply device. The central plug 58 is provided in conventional air treatment systems, for example for connecting to the energy supply and for connecting to a vehicle bus. The remote control 52 and/or the travel sensor 54 for the actuation of the lift axle device can also be connected directly to the central plug or in some other way by means of the vehicle bus. By means of the travel sensor 54, and possibly by means of other devices, the control device 14 detects whether leakage is present in the system of the pneumatic suspension. If this is the case, then a warning lamp is activated via the plug 58, and the lift axle device 42 is separated from the compressed air supply by the 3/2 valve 30 in order to prevent a pressure loss and to ensure that the required brake pressure is maintained.

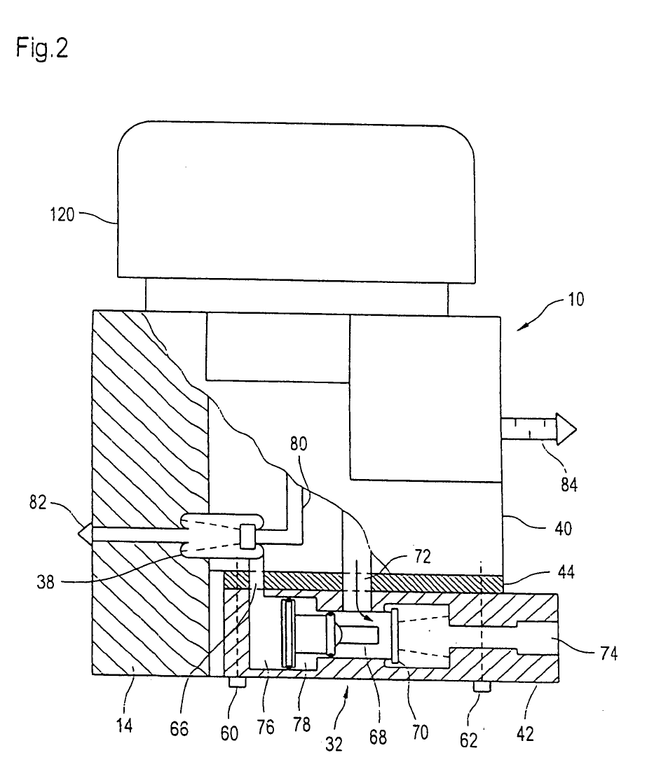

FIG. 2 shows a compressed air supply device according to the invention in a partially sectioned illustration. The compressed air supply device 10 includes a drier cartridge 120, which is seated on the housing of the air treatment module 40. A common noise damper 84 is provided for the entire compressed air supply device 10. The lift axle module 42 is attached to the air treatment module 40 via a seal 44 by way of screws 60, 62. The air treatment module 40 includes, in addition to other components, a multi-circuit protection valve, a pressure regulator and an electronic controller 14. The lift axle module 42 includes a valve device, with a 2/2 valve 32 being illustrated by way of example in the present illustration. By way of a control connection 66 between the air treatment module 40 and the lift axle module 42, a control space 76 upstream of a control piston 68 can be acted on with compressed air such that a valve plate 70, which is acted on with spring force, is raised from its valve seat. Compressed air can consequently flow via the compressed air inlet 72 through the 2/2 valve 32 to the compressed air outlet 74. After the control space 76 is relieved of pressure (i.e., ventilated), the valve plate 70 sets down again on the valve seat, so that the connection between the inlet 72 and the outlet 74 is interrupted. In order to permit unhindered movement of the control piston 68, the rear space 78 is equipped with a vent. The pilot control of the 2/2 valve 32 is carried out by use of a pilot-control solenoid valve 38, which is arranged in the air treatment module 40. The pilot-control solenoid valve 38 is supplied with compressed air via a compressed air supply 80. In the illustrated state, the solenoid valve 38 is preferably not supplied with current. If the solenoid valve 38 is moved into the state which is not illustrated, then the vent 82 is closed, and compressed air can pass into the control space 76 in order to actuate the 2/2 valve. In the illustrated state of the solenoid valve 38, venting of the control space 76 of the 2/2 valve takes place, so that the 2/2 valve can close or remains in the closed state.

In the present illustration as per FIG. 2, one of the 2/2 valves is illustrated by way of example. The further 2/2 valve and likewise the 3/2 valve are respectively situated behind and in front of the illustrated 2/2 valve and, therefore, cannot be seen in the present sectioned illustration. In contrast to the illustrated 2/2 valve 32, in the 3/2 valve, the control piston has a central bore which extends in the axial direction and a transverse bore which is preferably arranged transversely with respect to the central bore. The venting function of the 3/2 valve can be ensured in this way.

### TABLE OF REFERENCE SYMBOLS

10 Compressed air supply device

12 Compressed air inlet

14 Controller

16 Valve device

18 Lift axle device

20 Lift axle device

21 Compressed air outlet

22 Compressed air outlet

23 Compressed air outlet

23.1 Compressed air outlet

24 Outlet

26 Outlet

27 Outlet

28 Outlet

30 3/2 valve

32 2/2 valve

34 2/2 valve

36 Throttle

38 Pilot-control solenoid valve

40 Air treatment module

42 Lift axle module

44 Seal

50 Pressure sensor

52 Remote control

54 Travel sensor

56 Vehicle controller

58 Central plug

60 Screws

62 Screws

64 Pressure regulator

66 Control connection

68 Control piston

70 Valve plate

72 Compressed air inlet

74 Compressed air outlet

76 Control space

78 Rear space

80 Compressed air supply

82 Vent

84 Noise dampener

86 Multi-circuit protection valve

102 Heater

104 Temperature sensor

106 Pressure sensor

108 Pressure sensor

110 Pressure sensor

112 Pressure sensor

114 Solenoid valve

116 Solenoid valve

118 Solenoid valve

120 Drier cartridge

122 Blow-off valve

124 Pressure limiter

126 Overflow valve

128 Overflow valve

130 Overflow valve

132 Overflow valve

134 Supply line, service brake circuit

136 Supply line, lift axle device

138 Common supply line

140 Venting line, lift axle device

142 Common vent

144 Non-return valve

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A compressed air supply device having at least one compressed air inlet and a plurality of compressed air outlets for supplying treated compressed air to one or more brake circuits of a utility vehicle, the compressed air supply device having a control unit for controlling processes associated with supplying the treated compressed air, the compressed air supply device comprising:
an air treatment module;
a lift axle module;
a valve device arranged in the lift axle module, the valve device being actuatable by the control unit to directly control a filling and a venting of spring bellows of a pneumatic lift axle device with the treated compressed air;
one or more pilot control solenoid valves arranged in the air treatment module, the one or more pilot control solenoid valves providing pneumatic pilot control of the valve device; and
wherein the lift axle module is supplied with the treated compressed air from the air treatment module without interposition of an overflow valve.

2. The compressed air supply device as claimed in claim 1, further comprising in the lift axle module a 3/2 valve, and a 2/2 valve, connected downstream of said 3/2 valve in the supply flow direction, the 3/2 valve being switchable between filling and venting, and the 2/2 valve being switchable between open and blocked states.

3. The compressed air supply device as claimed in claim 2, further comprising a further 2/2 valve connected downstream of the 3/2 valve in the supply flow direction, the further 2/2 valve being switchable between open and blocked states, wherein each of the 2/2 valves is operatively arranged for filling and venting one spring bellows.

4. The compressed air supply device as claimed in claim 3, wherein the 2/2 valves are actuatable together.

5. The compressed air supply device as claimed in claim 3, wherein the 2/2 valves are actuatable separately.

6. The compressed air supply device as claimed in claim 3, further comprising a throttle, which permits an overflow of the compressed air between the spring bellows.

7. The compressed air supply device as claimed in claim 1, further comprising a supply line of a service brake circuit and a supply line of the lift axle module, which supply lines branch off from a common supply line.

8. A method for operating a compressed air supply device supplying one or more brake circuits of a utility vehicle with treated compressed air, the compressed air supply device including an air treatment module and a lift axle module having a valve device that directly controls filling and venting of spring bellows of a pneumatic lift axle device with the treated compressed air, the method comprising the acts of:
supplying the treated compressed air from the air treatment module to the air treatment module without passing through an overflow valve; and
pilot-controlling the valve device via pilot-control valves arranged in the air treatment module to control the filling and venting of the spring bellows of the pneumatic lift axle device with the supplied treated compressed air.

9. The method as claimed in claim 8, wherein a 3/2 valve and a 2/2 valve, which is connected downstream of said 3/2 valve in the supply flow direction, are provided, the method further comprising the acts of switching the 3/2 valve between filling and venting, and switching the 2/2 valve between open and blocked states.

10. The method as claimed in claim 9, wherein a further 2/2 valve is connected downstream of the 3/2 valve in the supply flow direction, the method further comprising the acts of switching the further 2/2 valve between open and blocked states, each of the 2/2 valves filling one spring bellows respectively.

11. The method as claimed in claim 10, further comprising the act of actuating the 2/2 valves together.

12. The method as claimed in claim 10, further comprising the act of actuating the 2/2 valves separately.
